(19) United States
(12) Patent Application Publication
(10) Pub. No.: US 2015/0317945 A1
(43) Pub. Date: Nov. 5, 2015

(54) SYSTEMS AND METHODS FOR GENERATING TINTED GLASS EFFECT FOR INTERFACE CONTROLS AND ELEMENTS

(71) Applicant: Yahoo! Inc., Sunnyvale, CA (US)

(72) Inventors: Scott Richard Andress, San Jose, CA (US); Rafael Vasconcellos Coelho, San Francisco, CA (US); Carrie Christina Merry Barkema, Sunnyvale, CA (US); Alicia Korn, San Francisco, CA (US); Vanessa Ilona Grass, San Francisco, CA (US)

(73) Assignee: Yahoo! Inc., Sunnyvale, CA (US)

(21) Appl. No.: 14/266,479

(22) Filed: Apr. 30, 2014

(51) Int. Cl. G09G 5/02; G06T 11/00; G06F 17/30

(52) U.S. Cl. CPC G09G 5/026; G06F 17/30657; G06T 11/001; G06T 2200/24; G06T 2210/62; G09G 2340/12; G09G 2320/0666; G09G 2320/0613; G09G 2320/0686

(57) ABSTRACT

A system stored in a non-transitory medium executable by processor circuitry is provided for generating a tinted glass visual effect. The system includes interface circuitry configured to receive a search query and query processing circuitry configured to identify a content item related to the search query and to retrieve data for the content item. Image editing circuitry is communicatively coupled to the query processing circuitry. The image editing circuitry is configured to identify a display element associated with the content item from the retrieved data, dynamically generate a semi-transparent portion of the display element, and apply the semi-transparent portion of the display element to a background of an interface element. Display logic circuitry is also communicatively coupled to the interface circuitry and is configured to display, in response to the search query, the interface element as a sub-portion of the display element associated with the content item.

### TECHNICAL FIELD

The present description relates generally to a system and method, generally referred to as a system, for generating tinted glass visual effects for interface controls and elements.

### BACKGROUND

It is common for users to enter a query consisting of one or more keywords and execute a search on a web page. Typically, search results are provided on a search results page that displays a list of links with titles. Individual search results may also be provided with a textual description of the linked content. In many cases, the list of results is accompanied by one or more sponsored results (i.e., search advertisements) that may be receive preferential display over unsponsored results.

Increasingly, users are executing searches on mobile devices, such as smartphones or tablets. However, the common technique of providing a list of results is not well adapted to the particular technical and use constraints of a mobile device. There is, therefore, a set of engineering problems to be solved in order to provide search results to users that are well adapted to mobile devices or mobile device interfaces to other devices (such as televisions).

### SUMMARY

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

In one aspect or embodiment, a system stored in a non-transitory medium executable by processor circuitry is provided. The system includes interface circuitry configured to receive a search query and query processing circuitry configured to identify a content item related to the search query and to retrieve data for the content item. Image editing circuitry is communicatively coupled to the query processing circuitry. The image editing circuitry is configured to identify a display element associated with the content item from the retrieved data, dynamically generate a semi-transparent portion of the display element, and apply the semi-transparent portion of the display element to a background of an interface element. Display logic circuitry is also communicatively coupled to the interface circuitry and is configured to display, in response to the search query, the interface element as a sub-portion of the display element associated with the content item.

In another aspect or embodiment, a computer-implemented method is provided. The method includes processing, by query processing circuitry communicatively coupled to a network communications circuitry, a search query to identify search result objects associated with the search query. A search result object associated with the search query and a graphical display element related to the search result object is then received at the network communications circuitry. Image editing circuitry then processes the graphical display element for the search result object to dynamically generate a semi-transparent portion of the graphical display element. The image editing circuitry then identifies an interface element associated with the search result object and applying the semi-transparent portion of the graphical display element as a background of the interface element. And the display logic circuitry generates display logic for displaying graphical search result objects to a user including the search result object and the semi-transparent portion of the graphical display element as a background of the interface element.

In a third aspect or embodiment, a system is provided that includes a means for receiving a user search query and identifying a graphical element associated with a search result object related to the search query. The system also includes a means for generating a tinted glass visual effect for a portion of the graphical element and a means for displaying the tinted glass visual effect on the portion of graphical element as part of a graphical search result related to the search query. The system further includes a means for outputting the graphical search result to be displayed on a display of a client device.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 illustrates a block diagram of an exemplary information system depicting example devices of an exemplary network that can provide aspects of a modular search object framework for utilizing tinted glass effects.

FIG. 2a illustrates entity and non-entity search result objects having tinted glass interface elements displayed on an example page view rendered by a client-side application executed on a mobile client-side device.

FIG. 2b illustrates partially expanded entity search result objects having tinted glass interface elements displayed on an example page view rendered by the client-side application executed on a mobile client-side device.

FIG. 3 illustrates an example expanded displayed entity search result object have tinted glass interface elements.

FIG. 4 illustrates entity and non-entity search result objects and search suggestion objects having tinted glass interface elements displayed on an example page view rendered by a client-side application, such as a web browser

FIG. 5 illustrates exemplary operations according to one embodiment that may be performed by the circuitry of a client device and/or a server-side device in an exemplary system in order to provide aspects of the modular search result object framework and to generate tinted class visual effects for graphical elements of the search result objects.

FIG. 6 illustrates exemplary operations according to one embodiment that may be performed by the circuitry of a client device and/or a server-side device in an exemplary system in order to provide aspects of the modular search result object framework and to generate tinted class visual effects for search result objects having multiple graphical elements and/or modules.

FIG. 7 illustrates exemplary operations that may be performed by the circuitry of a client device and/or a server-side device in an exemplary system in order to generate tinted glass visual effects for a graphical element according to one embodiment

FIG. 8 illustrates a block diagram of exemplary circuitry of a server in an exemplary system according to one embodiment that can provide aspects of the module search object framework and tinted glass visual effect.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

By way of introduction, systems and methods described herein may be utilized for implementing techniques to create tinted glass or frosted glass visual effects, referred to generally herein as “tinted glass” effects, for application to objects and elements of a user interface. In particular, various embodiments described herein may be utilized to apply a tinted glass visual effect to interface elements, including controls, action buttons, containers, and other objects, such as those that may allow a user to interact with a mobile application or mobile web experience. The tinted glass visual effect may be dynamically customized based on the target object or interface element or any sub-portion thereof that the visual effect is being applied to. In certain embodiments, customized forms of the tinted glass effect may be used as visual cues to provide an enhanced and intuitive user experience. Additionally, the tinted glass effect may advantageously be generated as a semi-transparent visual effect such that the tinted glass may be applied to one more graphical display elements, such as photographs, associated with the nature of the content item being displayed on the user interface.

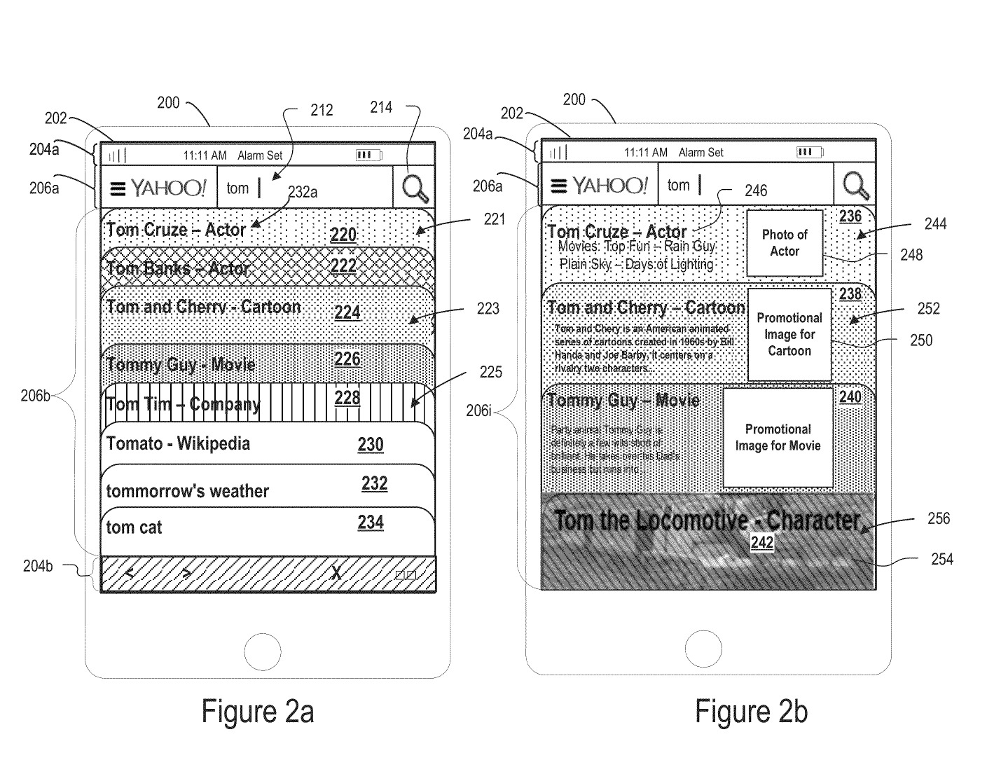

In some embodiments, various methods and systems described herein may be utilized as a portion of a modular search object framework, such as those that may be used to present enhanced mobile and web-based browsing experiences to users. For instance, commonly owned U.S. patent application Ser. No. XX/XXX, filed MM/DD/YYYY, entitled ______, which is hereby incorporated by reference in its entirety, describes a modular search object framework for displaying graphical search results for entity and non-entity search results and search suggestion objects. As described further in connection with FIGS. 2-4, tinted glass effects may provide one or more semi-transparent background layers to interactive objects and visual elements associated with entity and non-entity search result objects and search suggestion objects. Tinted glass effects may also be used to provide visual emphasis and/or cues to users of an application or web-browser, as well as to provide a more efficient and enhanced user experience.

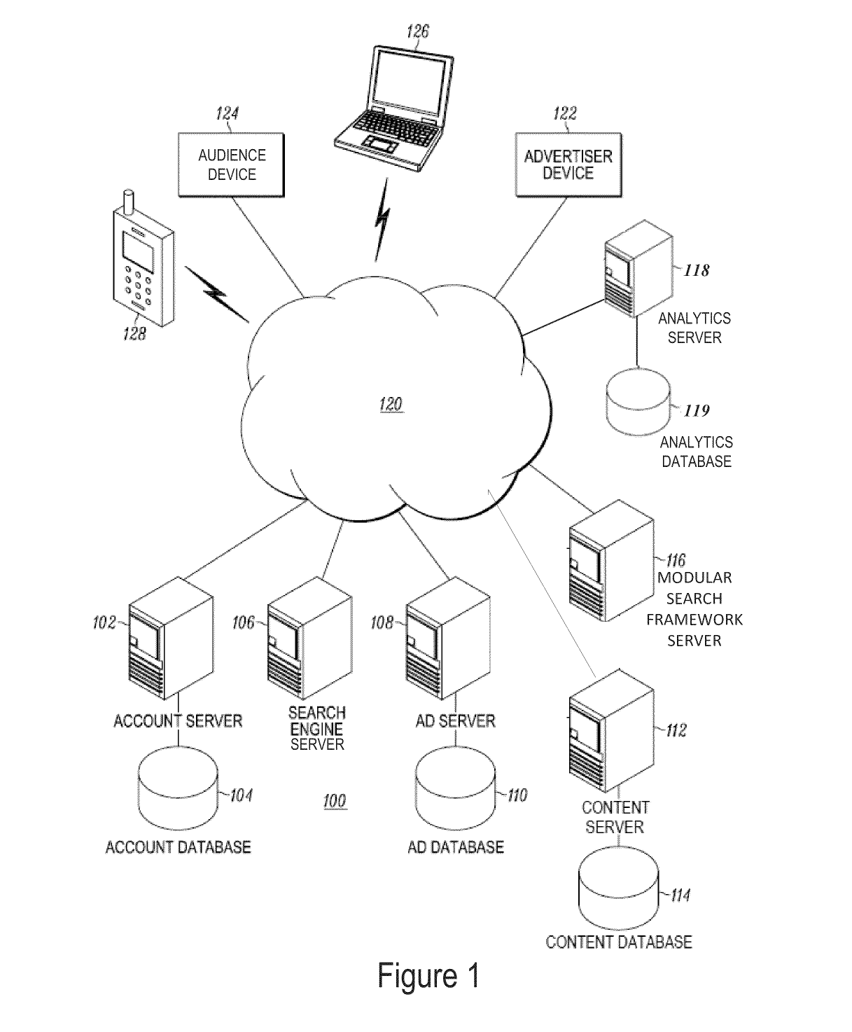

Referring now to the figures, FIG. 1 illustrates a block diagram of an exemplary information system depicting example devices of an exemplary network information system that can provide aspects of a modular search object framework for utilizing tinted glass effects. The information system 100 in the example of FIG. 1 includes an account server 102, an account database 104, a search engine server 106, an ad server 108, an ad database 110, a content database 114, a content server 112, a modular search framework server 116 (which can also be communicatively coupled with a corresponding database), an analytics server 118, and an analytics database 119. The aforementioned servers and databases can be communicatively coupled over a network 120. Additionally, one or more of the aforementioned servers and databases may form part of the same physical database or server or may consist of one or more distributed databases or servers communicatively coupled over a network, such as the Internet or an intranet.

The information system 100 may be accessible over the network 120 by advertiser devices, such as an advertiser client device 122 and by audience devices, such as an audience client device 124. An audience device can be a client device that presents online content, such as entity and non-entity search results, search suggestions, content, and advertisements, to a user. In various examples of such an online information system, users may search for and obtain content from sources over the network 120, such as obtaining content from the search engine server 106, the ad server 108, the ad database 110, the content server 112, the content database 114, and the modular search framework server 116. Advertisers may provide advertisements for placement on electronic properties, such as web pages, and other communications sent over the network to audience devices, such as the audience client device 124. The online information system can be deployed and operated by an online services provider, such as Yahoo! Inc.

The account server 102 stores account information for advertisers. The account server 102 is in data communication with the account database 104. Account information may include database records associated with each respective advertiser. Suitable information may be stored, maintained, updated and read from the account database 104 by the account server 102. Examples include advertiser identification information, advertiser security information, such as passwords and other security credentials, account balance information, and information related to content associated with their ads, and user interactions associated with their ads and associated content. Also, examples include analytics data related to their ads and associated content and user interactions with the aforementioned. In an example, the analytics data may be in the form of one or more sketches, such as in the form of a sketch per audience segment, segment combination, or at least part of a campaign. The account information may include ad booking information. This booking information can be used as input for determining ad impression availability.

The account server 102 may be implemented using a suitable device. The account server 102 may be implemented as a single server, a plurality of servers, or another type of computing device known in the art. Access to the account server 102 can be accomplished through a firewall that protects the account management programs and the account information from external tampering. Additional security may be provided via enhancements to the standard communications protocols, such as Secure HTTP (HTTPS) or the Secure Sockets Layer (SSL). Such security may be applied to any of the servers of FIG. 1, for example.

The account server 102 may provide an advertiser front end to simplify the process of accessing the account information of an advertiser (such as a client-side application). The advertiser front end may be a program, application, or software routine that forms a user interface. In a particular example, the advertiser front end is accessible as a website with electronic properties that an accessing advertiser may view on an advertiser device, such as the advertiser client device 122. The advertiser may view and edit account data and advertisement data, such as ad booking data, using the advertiser front end. After editing the advertising data, the account data may then be saved to the account database 104.

Also, audience analytics, impressions delivered, impression availability, and segments may be viewed in real time using the advertiser front end. The advertiser front end may be a client-side application, such as a client-side application running on the advertiser client device. A script and/or applet (such as a script and/or applet) may be a part of this front end and may render access points for retrieval of the audience analytics, impressions delivered, impression availability, and segments. In an example, this front end may include a graphical display of fields for selecting an audience segment, segment combination, or at least part of a campaign. The front end, via the script and/or applet, can request the audience analytics, impressions delivered, and impression availability for the audience segment, segment combination, or at least part of a campaign. The information can then be displayed, such as displayed according to the script and/or applet.

The search engine server 106 and/or the modular search framework server 116 may be one or more servers. Alternatively, the search engine server 106 and/or the modular search framework server 116 may be a computer program, instructions, or software code stored on a computer-readable storage medium that runs on one or more processors of one or more servers. The search engine server 106 and/or the modular search framework server 116 may be accessed by audience devices, such as the audience client device 124 operated by an audience member over the network 120. Access may be through graphical access points. For example, query entry box (such as the query entry box 212 illustrated in FIGS. 2a-2b) may be an access point for the user to submit a search query to search engine server 106 and/or the modular search framework server 116, from the audience client device 124. Search queries submitted or other user interactions with the search engine server 106 and/or the modular search framework server 116 can be logged in data logs, and such logs may be communicated to the analytics server 118 for processing. After processing, the analytics server 118 can output corresponding analytics data to be served to the search engine server 106 and/or the modular search framework server 116 for determining entity and non-entity non-sponsored search results, entity and non-entity sponsored search results, and other types of content and ad impressions. Analytic circuitry may be used to determine analytics data, and such circuitry may be embedded in any one of the servers and client devices illustrated in FIG. 1.

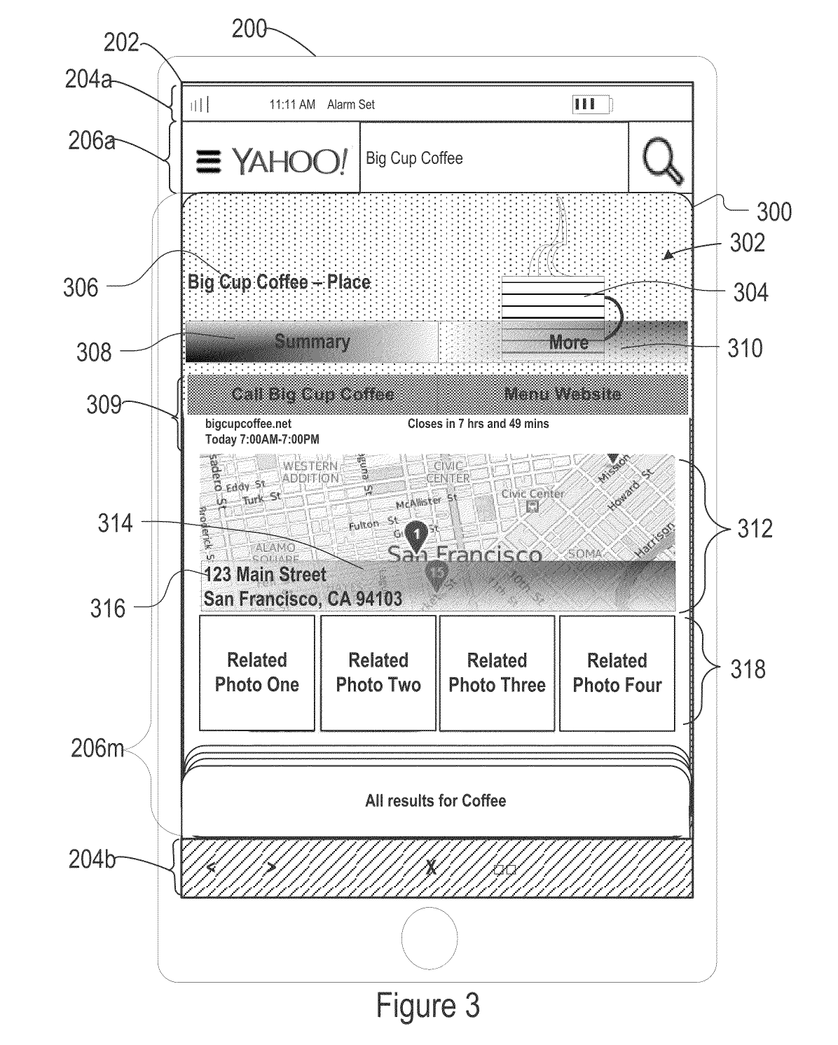

Besides a search query, the audience client device 124 can communicate interactions with a search result and/or a search suggestion, such as interactions with a sub-GUI associated with the search result appearing on the same page view as the search result. Such interactions can be communicated to the search engine server 106, the modular search framework server 116, and/or the analytics server 118, for example. The search engine server 106 and/or the modular search framework server 116 locates matching information using a suitable protocol or algorithm and returns information to the audience client device 124, such as in the form of search suggestions, entity search results, and non-entity search results. An example of non-entity search results can include a list of webpage search results. Webpage search results may include a link to a corresponding webpage and a short corresponding blurb and/or text scraped from the webpage. The search engine server 106 and/or the modular search framework server 116 may receive the user interaction information, that can include search queries, from an audience device, and send corresponding information to the ad server 108 and/or the content server 112, and the ad server 108 and/or the content server 112 may serve corresponding ads and/or search results, but with more in-depth details or accompanying GUIs and sub-GUI for interacting with subject matter associated with ads, entity search results, and/or non-entity search results. The information inputted and/or outputted by these devices may be logged in data logs and communicated to the analytics server 118 for processing, over the network 120. The analytics server 118 can provide analyzed feedback for affecting future serving of content. For example, the analytics server 118 can provide feedback for affecting serving of ads, search suggestions, entity search results, non-entity search results, and respective GUIs and sub-GUIs (including modular portions of a GUI, such as GUI elements discussed in connection with elements 308, 310, 312, and 318 of FIG. 3), and included with and/or associated with the ads, search suggestions, entity search results, and non-entity search results.

The search engine server 106 and/or the modular search framework server 116 may be designed to help users and potential audience members find information located on the Internet or an intranet. In an example, the search engine server 106 and/or the modular search framework server 116 may also provide to the audience client device 124 over the network 120 an electronic property, such as a web page and/or entity tray, with content, including search results, information matching the context of a user inquiry, links to other network destinations, or information and files of information of interest to a user operating the audience client device 124, as well as a stream or web page of content items and advertisement items selected for display to the user. This information provided by the search engine server 106 and/or the modular search framework server 116 may also be logged, and such logs may be communicated to the analytics server 118 for processing, over the network 120. Once processed into corresponding analytics data, the analytics server 118 can provide analyzed feedback for affecting future serving of content. For example, the analytics server 118 can provide feedback for affecting serving of ads, search suggestions, entity search results, non-entity search results, and respective GUIs and sub-GUIs included with and/or associated with the ads, search suggestions, entity search results, and non-entity search results.

The search engine server 106 and/or the modular search framework server 116 may enable a device, such as the advertiser client device 122, the audience client device 124, or another type of client device, to search for files of interest using a search query, such as files associated with entity trays. Typically, the search engine server 106 and/or the modular search framework server 116 may be accessed by a client device via servers or directly over the network 120. The search engine server 106 and/or the modular search framework server 116 may include a crawler component, an indexer component, an index storage component, a search component, a ranking component, a cache, a user or group profile storage component, an entity storage component, a logon component, a user or group profile builder, an entity builder, and application program interfaces (APIs), such as APIs corresponding with the modular search framework. The search engine server 106 and/or the modular search framework server 116 may be deployed in a distributed manner, such as via a set of distributed servers, for example. Components may be duplicated within a network, such as for redundancy or better access.

The ad server 108 operates to serve advertisements to audience devices, such as the audience client device 124. An advertisement may include text data, graphic data, image data, video data, or audio data. Advertisements may also include data defining advertisement information that may be of interest to a user of an audience device. The advertisements may also include respective audience targeting information or ad campaign information, such as information on audience segments and segment combinations. An advertisement may further include data defining links to other online properties reachable through the network 120, such as entity trays and other types of properties related to entity trays. Also, an entity GUIs and other types of properties (such as entity trays and sub-GUIs related to entity trays) may be or include an advertisement. The aforementioned audience targeting information and the other data associated with an ad may be logged in data logs and such logs may be communicated to the analytics server 118 for processing. Once processed into corresponding analytics data, the analytics server 118 can provide analyzed feedback for affecting future serving of content. For example, the analytics server 118 can provide feedback for affecting serving of ads, search suggestions, entity search results, non-entity search results, and respective GUIs and sub-GUIs included with and/or associated with the ads, search suggestions, entity search results, and non-entity search results.

For online service providers, advertisements may be displayed on electronic properties resulting from a user-defined search based, at least in part, upon search terms. Advertising may be beneficial to users, advertisers or web portals if displayed advertisements are relevant to audience segments, segment combinations, or at least parts of campaigns. Thus, a variety of techniques have been developed to determine corresponding audience segments or to subsequently target relevant advertising to audience members of such segments. For example user interests, user intentions, and targeting data related to segments or campaigns may be may be logged in data logs and such logs may be communicated to the analytics server 118 for processing. Once processed into corresponding analytics data, the analytics server 118 can provide analyzed feedback for affecting future serving of content. For example, the analytics server 118 can provide feedback for affecting serving of ads, search suggestions, entity search results, non-entity search results, and respective GUIs and sub-GUIs included with and/or associated with the ads, search suggestions, entity search results, and non-entity search results.

One approach to presenting targeted advertisements includes employing demographic characteristics (such as age, income, sex, occupation, etc.) for predicting user behavior, such as by group. Advertisements may be presented to users in a targeted audience based, at least in part, upon predicted user behavior. The aforementioned targeting data, such as demographic data and psychographic data, may be logged in data logs and such logs may be communicated to the analytics server 118 for processing. Once processed into corresponding analytics data, the analytics server 118 can provide analyzed feedback for affecting future serving of content. For example, the analytics server 118 can provide feedback for affecting serving of ads, search suggestions, entity search results, non-entity search results, and respective GUIs and sub-GUIs included with and/or associated with the ads, search suggestions, entity search results, and non-entity search results.

Another approach includes profile-type ad targeting. In this approach, user or group profiles specific to a respective user or group may be generated to model user behavior, for example, by tracking a user's path through a website or network of sites, and compiling a profile based, at least in part, on entity GUIs (such as modular components of an entity card), web pages, and advertisements ultimately delivered. A correlation may be identified, such as for user purchases, for example. An identified correlation may be used to target potential purchasers by targeting content or advertisements to particular users. The aforementioned profile-type targeting data may be logged in data logs and such logs may be communicated to the analytics server 118 for processing. Once processed into corresponding analytics data, the analytics server 118 can provide analyzed feedback for affecting future serving of content. For example, the analytics server 118 can provide feedback for affecting serving of ads, search suggestions, entity search results, non-entity search results, and respective GUIs and sub-GUIs included with and/or associated with the ads, search suggestions, entity search results, and non-entity search results.

Yet another approach includes targeting based on content of an electronic property requested by a user, such as content of an entity GUI (such as a module component of an entity card) or webpage requested by a user. Advertisements may be placed on an electronic property or in association with other content that is related to the subject of the advertisements. The relationship between the content and the advertisement may be determined in a suitable manner. The overall theme of a particular electronic property may be ascertained, for example, by analyzing the content presented therein. Moreover, techniques have been developed for displaying advertisements geared to the particular section of the article currently being viewed by the user. Accordingly, an advertisement may be selected by matching keywords, and/or phrases within the advertisement and the electronic property. The aforementioned targeting data may be logged in data logs and such logs may be communicated to the analytics server 118 for processing. Once processed into corresponding analytics data, the analytics server 118 can provide analyzed feedback for affecting future serving of content. For example, the analytics server 118 can provide feedback for affecting serving of ads, search suggestions, entity search results, non-entity search results, and respective GUIs and sub-GUIs included with and/or associated with the ads, search suggestions, entity search results, and non-entity search results.

The ad server 108 includes logic and data operative to format the advertisement data for communication to a user device, such as an audience member device. The ad server 108 is in data communication with the ad database 110. The ad database 110 stores information, including data defining advertisements, to be served to user devices. This advertisement data may be stored in the ad database 110 by another data processing device or by an advertiser. The advertising data may include data defining advertisement creatives and bid amounts for respective advertisements and/or audience segments. The aforementioned ad formatting and pricing data may be logged in data logs and such logs may be communicated to the analytics server 118 for processing. Once processed into corresponding analytics data, the analytics server 118 can provide analyzed feedback for affecting future serving of content. For example, the analytics server 118 can provide feedback for affecting serving of ads, search suggestions, entity search results, non-entity search results, and respective GUIs and sub-GUIs included with and/or associated with the ads, search suggestions, entity search results, and non-entity search results.

The advertising data may be formatted to an advertising item that may be included in a stream of content items and advertising items provided to an audience device. The formatted advertising items can be specified by appearance, size, shape, text formatting, graphics formatting and included information, which may be standardized to provide a consistent look and feel for advertising items in the stream. Such a stream may be included in or combined with an entity GUI (such as an entity tray). Also, a related entity GUI can include a similar appearance, size, shape, text formatting, graphics formatting and included information to provide a consistent look and feel between the entity GUI and the stream. Additionally, aforementioned formatting data may be logged in data logs and such logs may be communicated to the analytics server 118 for processing. Once processed into corresponding analytics data, the analytics server 118 can provide analyzed feedback for affecting future serving of content. For example, the analytics server 118 can provide feedback for affecting serving of ads, search suggestions, entity search results, non-entity search results, and respective GUIs and sub-GUIs included with and/or associated with the ads, search suggestions, entity search results, and non-entity search results.

Further, the ad server 108 is in data communication with the network 120. The ad server 108 communicates ad data and other information to devices over the network 120. This information may include advertisement data communicated to an audience device. This information may also include advertisement data and other information communicated with an advertiser device, such as the advertiser client device 122. An advertiser operating an advertiser device may access the ad server 108 over the network to access information, including advertisement data. This access may include developing advertisement creatives, editing advertisement data, deleting advertisement data, setting and adjusting bid amounts and other activities. This access may also include a portal for interacting with, viewing analytics associated with, and editing parts of entity GUIs (such as module components of an entity card) the advertiser at least partially controls or owns. The ad server 108 then provides the ad items and/or entity GUIs to other network devices, such as the modular search framework server 116, the analytics server 118, and/or the account server 102, for classification (such as associating the ad items and/or entity GUIs with audience segments, segment combinations, or at least parts of campaigns). This information can be used to provide feedback for affecting serving of ads, search suggestions, entity search results, non-entity search results, and respective GUIs and sub-GUIs included with and/or associated with the ads, search suggestions, entity search results, and non-entity search results.

The ad server 108 may provide an advertiser front end to simplify the process of accessing the advertising data of an advertiser. The advertiser front end may be a program, application or software routine that forms a user interface. In one particular example, the advertiser front end is accessible as a website with electronic properties that an accessing advertiser may view on the advertiser device. The advertiser may view and edit advertising data using the advertiser front end. After editing the advertising data, the advertising data may then be saved to the ad database 110 for subsequent communication in advertisements to an audience device.

The ad server 108, the content server 112, or any other server described herein may be one or more servers. Alternatively, the ad server 108, the content server 112, or any other server described herein may be a computer program, instructions, and/or software code stored on a computer-readable storage medium that runs on one or more processors of one or more servers. The ad server 108 may access information about ad items either from the ad database 110 or from another location accessible over the network 120. The ad server 108 communicates data defining ad items and other information to devices over the network 120. The content server 112 may access information about content items either from the content database 114 or from another location accessible over the network 120. The content server 112 communicates data defining content items and other information to devices over the network 120. Content items and the ad items may include any form of content included in ads, search suggestions, entity search results, non-entity search results, and respective GUIs and sub-GUIs included with and/or associated with the ads, search suggestions, entity search results, and non-entity search results.

The information about content items may also include content data and other information communicated by a content provider operating a content provider device, such as respective audience segment information and possible links to entity search results, trays, and other types of entity GUIs. A content provider operating a content provider device may access the content server 112 over the network 120 to access information, including the respective segment information, entity search result information, and entity GUI information. This access may be for developing content items, editing content items, deleting content items, setting and adjusting bid amounts and other activities, such as associating content items with audience segments, segment combinations, or at least parts of campaigns. A content provider operating a content provider device may also access the analytics server 118 over the network 120 to access analytics data. Such analytics may help focus developing content items, editing content items, deleting content items, setting and adjusting bid amounts, and activities related to distribution of the content, such as distribution of content via entity search results and GUIs (such as modular components of an entity card).

The content server 112 may provide a content provider front end to simplify the process of accessing the content data of a content provider. The content provider front end may be a program, application or software routine that forms a user interface. In a particular example, the content provider front end is accessible as a website with electronic properties that an accessing content provider may view on the content provider device. The content provider may view and edit content data using the content provider front end. After editing the content data, such as at the content server 112 or another source of content, the content data may then be saved to the content database 114 for subsequent communication to other devices in the network 120, such as devices administering entity search results and GUIs.

The content provider front end may be a client-side application, such as a client-side application running on the advertiser client device or the audience client device, respectively. A script and/or applet, such as the script and/or applet, may be a part of this front end and may render access points for retrieval of impression availability data (such as the impression availability data), and the script and/or applet may manage the retrieval of the impression availability data. In an example, this front end may include a graphical display of fields for selecting audience segments, segment combinations, or at least parts of campaigns. Then this front end, via the script and/or applet, can request the impression availability for the audience segments, segment combinations, or at least parts of campaigns. The analytics can then be displayed, such as displayed according to the script and/or applet. Such analytics may also be used to provide feedback for affecting serving of ads, search suggestions, entity search results, non-entity search results, and respective GUIs and sub-GUIs included with and/or associated with the ads, search suggestions, entity search results, and non-entity search results

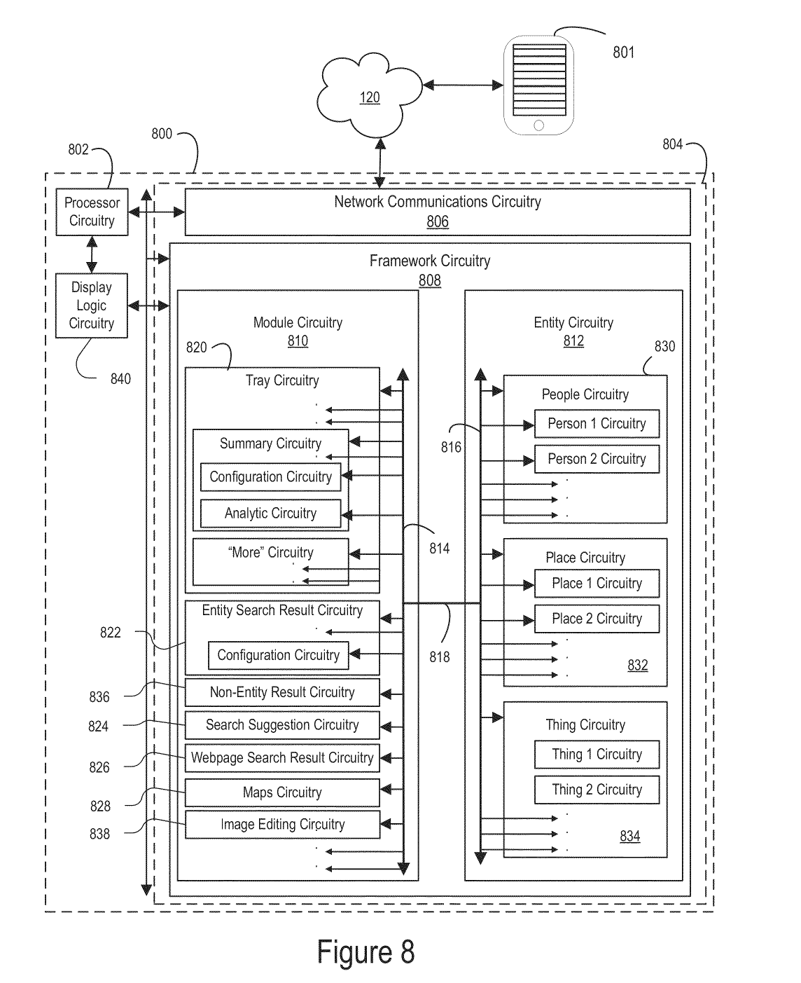

The content server 112 includes logic and data operative to format content data for communication to the audience device. The content server 112 can provide content items or links to such items to the analytics server 118 and/or the modular search framework server 116 for analysis or associations with entities, respectively. For example, content items and links may be matched to data and circuitry, such as entity data and circuitry and even module circuitry and data (e.g., module circuitry 810 in FIG. 8). The matching may be complex and may be based on historical information related to the audience segments and impression availability. Techniques for matching content items and links to the audience segments are numerous and beyond the scope of this application.

The content data may be formatted to a content item that may be included in a stream of content items and advertisement items provided to an audience device. The formatted content items can be specified by appearance, size, shape, text formatting, graphics formatting and included information, which may be standardized to provide a consistent look and feel for content items in the stream. Such a stream may be included in or combined with an entity GUI (such as modular components of an entity card). Also, a related entity GUI can include a similar appearance, size, shape, text formatting, graphics formatting and included information to provide a consistent look and feel between the entity GUI and the stream. Additionally, aforementioned formatting data may be logged in data logs and such logs may be communicated to the analytics server 118 for processing. Once processed into corresponding analytics data, the analytics server 118 can provide analyzed feedback for affecting future serving of content. For example, the analytics server 118 can provide feedback for affecting serving of ads, search suggestions, entity search results, non-entity search results, and respective GUIs and sub-GUIs included with and/or associated with the ads, search suggestions, entity search results, and non-entity search results.

In an example, the content items may have an associated bid amount that may be used for ranking or positioning the content items in a stream of items presented to an audience device. In other examples, the content items do not include a bid amount, or the bid amount is not used for ranking the content items. Such content items may be considered non-revenue generating items. The bid amounts and other related information may be logged in data logs and such logs may be communicated to the analytics server 118 for processing. Once processed into corresponding analytics data, the analytics server 118 can provide analyzed feedback for affecting future serving of content. For example, the analytics server 118 can provide feedback for affecting serving of ads, search suggestions, entity search results, non-entity search results, and respective GUIs and sub-GUIs included with and/or associated with the ads, search suggestions, entity search results, and non-entity search results.

The aforementioned servers and databases may be implemented through a computing device. A computing device may be capable of sending or receiving signals, such as over a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally, a server may include a central processing unit and memory. A server may also include a mass storage device, a power supply, wired and wireless network interfaces, input/output interfaces, and/or an operating system, such as Windows Server, Mac OS X, UNIX, Linux, FreeBSD, or the like.

The aforementioned servers and databases may be implemented as online server systems or may be in communication with online server systems. An online server system may include a device that includes a configuration to provide data via a network to another device including in response to received requests for page views, entity search results and GUIs (such as entity trays), or other forms of content delivery. An online server system may, for example, host a site, such as a social networking site, examples of which may include, without limitation, Flicker, Twitter, Facebook, LinkedIn, or a personal user site (such as a blog, vlog, online dating site, etc.). Such sites may be integrated with the framework via the modular search framework server 116. An online server system may also host a variety of other sites, including, but not limited to business sites, educational sites, dictionary sites, encyclopedia sites, wikis, financial sites, government sites, etc. These sites, as well, may be integrated with the framework via the modular search framework server 116.

An online server system may further provide a variety of services that may include web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may or may not be under common ownership or control with the servers and databases described herein.

The network 120 may include a data communication network or a combination of networks. A network may couple devices so that communications may be exchanged, such as between a server and a client device or other types of devices, including between wireless devices coupled via a wireless network, for example. A network may also include mass storage, such as a network attached storage (NAS), a storage area network (SAN), or other forms of computer or machine readable media, for example. A network may include the Internet, local area networks (LANs), wide area networks (WANs), wire-line type connections, wireless type connections, or any combination thereof. Likewise, sub-networks, may employ differing architectures or may be compliant or compatible with differing protocols, and may interoperate within a larger network, such as the network 120.

Various types of devices may be made available to provide an interoperable capability for differing architectures or protocols. For example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links, including satellite links, or other communication links or channels, such as may be known to those skilled in the art. Furthermore, a computing device or other related electronic devices may be remotely coupled to a network, such as via a telephone line or link, for example.

The advertiser client device 122 includes a data processing device that may access the information system 100 over the network 120. The advertiser client device 122 is operative to interact over the network 120 with any of the servers or databases described herein. The advertiser client device 122 may implement a client-side application for viewing electronic properties and submitting user requests. The advertiser client device 122 may communicate data to the information system 100, including data defining electronic properties and other information. The advertiser client device 122 may receive communications from the information system 100, including data defining electronic properties and advertising creatives. The aforementioned interactions and information may be logged in data logs and such logs may be communicated to the analytics server 118 for processing. Once processed into corresponding analytics data, the analytics server 118 can provide analyzed feedback for affecting future serving of content. For example, the analytics server 118 can provide feedback for affecting serving of ads, search suggestions, entity search results, non-entity search results, and respective GUIs and sub-GUIs included with and/or associated with the ads, search suggestions, entity search results, and non-entity search results.

In an example, content providers may access the information system 100 with content provider devices that are generally analogous to the advertiser devices in structure and function. The content provider devices provide access to content data in the content database 114, for example.

The audience client device 124 includes a data processing device that may access the information system 100 over the network 120. The audience client device 124 is operative to interact over the network 120 with the search engine server 106, the ad server 108, the content server 112, and the analytics server 118, and the modular search framework server 116. The audience client device 124 may implement a client-side application for viewing electronic content and submitting user requests. A user operating the audience client device 124 may enter a search request and communicate the search request to the information system 100. The search request is processed by the search engine and search results are returned to the audience client device 124. The aforementioned interactions and information may be logged in data logs and such logs may be communicated to the analytics server 118 for processing. Once processed into corresponding analytics data, the analytics server 118 can provide analyzed feedback for affecting future serving of content. For example, the analytics server 118 can provide feedback for affecting serving of ads, search suggestions, entity search results, non-entity search results, and respective GUIs and sub-GUIs included with and/or associated with the ads, search suggestions, entity search results, and non-entity search results.

In other examples, a user of the audience client device 124 may request data, such as a page of information from the online information system 100. The data instead may be provided in another environment, such as a native mobile application, TV application, or an audio application. The online information system 100 may provide the data or re-direct the browser to another source of the data. In addition, the ad server may select advertisements from the ad database 110 and include data defining the advertisements in the provided data to the audience client device 124. The aforementioned interactions and information may be logged in data logs and such logs may be communicated to the analytics server 118 for processing. Once processed into corresponding analytics data, the analytics server 118 can provide analyzed feedback for affecting future serving of content. For example, the analytics server 118 can provide feedback for affecting serving of ads, search suggestions, entity search results, non-entity search results, and respective GUIs and sub-GUIs included with and/or associated with the ads, search suggestions, entity search results, and non-entity search results.

The advertiser client device 122 and the audience client device 124 operate as a client device when accessing information on the information system 100. A client device, such as the advertiser client device 122 and the audience client device 124 may include a computing device capable of sending or receiving signals, such as via a wired or a wireless network. For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the foregoing devices, or the like. In the example of FIG. 1, both laptop computer 126 and smartphone 128, which can be client devices, may be operated as either an advertiser device or an audience device. A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include a physical or virtual keyboard, mass storage, an accelerometer, a gyroscope, global positioning system (GPS) or other location-identifying type capability, or a display with a high degree of functionality, such as a touch-sensitive color 2D or 3D display, for example.

A client device, such as the advertiser client device 122 and the audience client device 124, may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally or remotely stored or streamed video, or video games. The foregoing is provided to illustrate that claimed subject matter is intended to include a wide range of possible features or capabilities. At least some of the features, capabilities, and interactions with the aforementioned may be logged in data logs and such logs may be communicated to the analytics server 118 for processing. Once processed into corresponding analytics data, the analytics server 118 can provide analyzed feedback for affecting future serving of content. For example, the analytics server 118 can provide feedback for affecting serving of ads, search suggestions, entity search results, non-entity search results, and respective GUIs and sub-GUIs included with and/or associated with the ads, search suggestions, entity search results, and non-entity search results.

Also, the disclosed methods and systems may be implemented at least partially in a cloud-computing environment, at least partially in a server, at least partially in a client device, or in any combination thereof.

Not all of the depicted components in FIG. 1 may be in every system, however, and some implementations may include additional components not shown in the figure. Variations in the arrangement and type of the components may be made without departing from the spirit or scope of the claims as set forth herein.

FIGS. 2-4 show example screens of navigation of content items, such as online content, emphasizing various features provided by the framework. FIG. 2a illustrates entity and non-entity search result objects having tinted glass interface elements displayed on an example page view rendered by a client-side application, such as may be executed on a mobile client-side device. FIG. 2a shows an exemplary client-side application running on a mobile client device 200. The client-side application may be, for example, a mobile browser, web-based application, or native application running on a client device, such as a smart phone. The mobile client device 200 may include display 202 having graphical user interface (GUI) elements that a provided by the native operating system as part of the device experience, such as notification bar 204(a) and input keyboard (not displayed) that may be displayed or hidden depending on whether the user is interacting with a text field. Similarly, sections 206a and 206c are GUI elements provided by the client-side application executed on display 202 of mobile client device 200, such as a web browser or native application. Mobile client device 200 also includes a touch screen portion 206b that displays content in the remaining area of the device touch screen and allows a user to interact with the displayed content.

FIG. 2a shows search query text “tom” entered in to a search query box 212, such as via a native keyboard (not displayed). Alternatively, the text may be inputted through a voice command or other form of user input provided by the mobile application and/or native operating system. Upon entering of “tom” into the search query box 212 search suggestions and/or search results may be automatically generated, such as by query processing circuitry on mobile client device 200, and displayed on the display 202 within section 206b. For example, upon entering “tom” into the search query box 212, but before clicking on the search execution button 214, search topic suggestions may appear, such as search suggestions 220-234. A user may select one of these suggestions, which causes execution of a query using the respective text displayed with the suggestion. In this example, search suggestions appear as cards rendered by display logic circuitry on display 202.

Also, upon entering “tom” into the box 212, actual search results may appear, such as search results associated with a specific entity, such as a particular person, place, or thing. In this example, the entity search results include search results 220, 222, 224, 226, and 228. The results for these entities appear as cards. Similarly, non-entity search results 230 and search suggestions 232, 234 may also be displayed in display portion 206b in response to the user search query. In this example, non-entity search results include webpage results related to the search query. Similarly, search suggestions 232, 234 include dynamically generated suggestions, such as based on historical browsing data for the user or other similar users. The search result objects 232-234 may be displayed when execute search button 214 is pressed, or may be displayed and updated in real-time as the user is entering a search query in the search query box 212.

In either scenario, the search result cards may have different color and textural schemes, and may include schemes associated with a photograph or other graphical element, such as a photograph bled out onto a card. The search result card objects may also include tinted glass visual effects dynamically generated based on those graphical elements and color and textural schemes. These visual features provide visual cues to a user and allow the user to quickly distinguish between a graphical search result card or object, such as an entity search result card, and a search suggestion or non-entity card. Where a search is actually executed, and search results are displayed (such as in sections 206b of FIGS. 2a and 206i of FIG. 2b), an entity search result object can be visually distinguished from a set of webpage search results by the color and texture scheme of the card object representing the results as well. For example, a simple one color range theme may represent a set of webpage search results, whereas a more complex theme, such as a bled out photograph and/or tinted glass effect, may represent an entity search result. In FIG. 2a, entity search results (220-228) are visually distinguishable from webpage based search results 230 and search suggestions 232, 234.

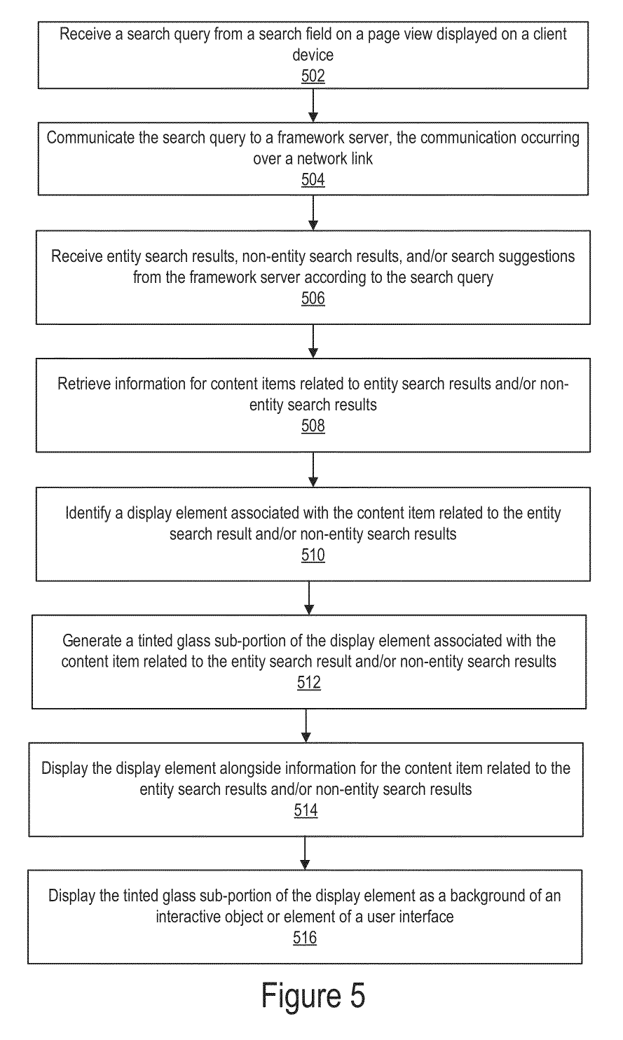

In some embodiments, these search suggestion cards may have a similar color and texture scheme, and the scheme may be simple, such as one solid color or a spectrum of colors with in a range of a full spectrum of colors. For example, the suggestion cards may each be various shades of blue. In alternative embodiments, one or more system circuitry components may allow the application or mobile browser to distinguish between general search results, search suggestion objects, entity search results, and non-entity search results, or any combination thereof. For example, although other schemes are imagined within the spirit and scope of the present description, one color scheme may display general search results and suggestions as cards having a plain or static color background. Content for cards associated with entity and/or non-entity search results, on the other hand, may be processed using image editing circuitry and displayed using the tinted glass feature, such as described further in connection with FIGS. 5-7.

As illustrated in FIGS. 2a, 2b, 3, and 4, the tinted glass visual effect may be applied to multiple interface elements in a mobile application and mobile web experience, including card backgrounds, controls, action buttons, containers, and other elements. In FIG. 2a, system circuitry may identify cards 220, 222, 224, 226, 228 as entity cards, generate a tinted glass background, and apply the background to the entity card as a modified backdrop with the alphanumeric text for the entity displayed on top of the tinted glass effect. In some embodiments, the color scheme for the tinted glass may be chosen based on a category or content type associated with the identified entity. For example, the tinted glass effect for backdrop 221 of entity card 220 may be generated using one color scheme because entity card 220 is for a search result falling in the category “Actor.” Similarly, backdrop 223 of entity card 224 may be generated using a second color because entity card 224 is for a search result falling in the category “Cartoon.” Likewise, backdrop 225 may receive a third color associated with the category “Company.” There may any number of a categories and color schemes associated with each. Additionally, categories may be organized into a hierarchical scheme where similar categories, such as those having a parent-child relationship or falling with in the same genus, receive similar color schemes.

In other embodiments, the color scheme for the tinted glass may be dynamically generated by processing a photographic or graphical element associated with the entity to select a color tint value based on the color palette of the graphical element. For example, FIG. 2b depicts entity cards 236, 238, 240, 242 as search result objects in a partially expanded view. While in partially expanded view, system circuitry may retrieve information and photographic elements associated with each entity card. The information and photographic or graphic element may be displayed as part of a modified backdrop for the entity. For example, entity card 236 is displayed as a partially expanded card having modified backdrop 244 containing related information 246 and graphical element 248, which may be a picture associated with the entity. Similarly, entity card 238 has graphical element 250 associated with the subject entity of the card. Graphical elements 248 and 250 may have different color palettes or may have a different color as the predominate color of the photograph. The system circuitry, such as imagine editing circuitry and display logic circuitry, may individually and dynamically process each of the graphical elements 248 and 250 for entity cards 236 and 238, respectively, to dynamically generate a different tinted glass effect for each backdrop 244 and 252. In this example, the modified backdrops 244 and 252 will have a tinted glass with a color scheme selected based on an analysis of the photographic or graphical element associated with each card or graphical search result object 236 and 238, respectively. For example, the respective color scheme for each backdrop may be selected based on which colors determined to be predominate colors in the respective graphical element. If graphical element 248 had a predominately blue color palette, then the tinted glass for modified background 244 could be generated using a similar blue hue or color scheme. Likewise, if graphical element 250 had a predominately yellow color palette, the modified backdrop 252 could be generated using a yellow hue or color scheme. In this way, the system is able to provide a dynamic and enhanced user experience.

In addition, in some embodiments, backdrops may be modified to display the graphical element as a semi-transparent background having a similar tinted glass feel. For example, entity card 242 has modified backdrop 256 having an enlarged graphical element 254. In this example, the tinted glass effect has been applied to graphical element as a modified backdrop has been created to use as the entire background of entity card 242. The semi-transparent nature of the tinted glass visual effect allows the graphical element 254 to be partially visible under the tinted or frosted glass features, which is illustrated by the diagonal fill lines A similar process could be used to generate enlarged graphical elements for all or some of the entity cards 236, 238, 240, 242. Likewise, the tinted glass effect may apply to the entire background of the entity card as well as form a semi-transparent layer over the smaller graphical elements displayed for entity cards 236, 238, and 240. In either scenario, the user is able to preview an image associated with the entity card along with the alphanumeric text displayed on the card but also receive visual cues from the tinted glass visual effect. In addition to providing an enhanced search experience, these features may allow a user to quickly and efficiently navigate the displayed search results.

Referring now to FIG. 3, an exemplary expanded displayed entity search result object having tinted glass interface elements is depicted. In this example, the search result entity is a full-size entity card displayed in display portion 206m. Full-size entity cards, such as card 300 for “Big Cup Coffee” may be displayed directly in a response to a user search query for “Big Cup Coffee” or may be displayed in response to a user selecting a contracted or condensed view of an entity search result object, such as described in connection with FIG. 2a, or a partially expanded entity search result object, such as described in connection with FIG. 2b. The fully expanded or full-size entity card may provide information specific to the subject entity or other entities related to that entity that may be generated by one or more circuits as described in connection with FIG. 8. Besides a specific person (a real person or a fictional character), entities may include any particular place or thing. For example, section 206m in FIG. 3 depicts a place entity card, for the entity “Big Cup Coffee.” Individual entity cards may form part of an expansive hierarchy and network of people, places, and things that have various types of relationships. For example, these relationships may include object relationships such as from the perspective of an object hierarchy including relationships between generic items and specific items, such as coffee shops in general and Big Cup Coffee in a more specific item.

Referring back to FIG. 3, a full-size entity card may display information related to the subject of the entity card. The information may be dynamically generated by one or more circuitry related to each of the modular components of the entity card. Each modular component has respective circuitry configured to execute various aspects of the module that may change depending on the nature of the module as described further in FIG. 8. For example, in FIG. 3, the GUI is depicted as having summary content 309 rendered by an entity summary module and controlled by respective summary circuitry and or entity circuitry. This summary GUI includes summary information regarding the selected entity. Because the selected entity is a place or business, the summary module may generate summary information such as hours of operation, website address, time before the business closes, call or other contact buttons, and/or links to website menu.

Similarly, the GUI may contain other modules implemented by their respective circuitry such as a mapping module implemented by maps circuitry to generate and the display map section 312, a “more” module to generate and display a button 310 allowing the user to search for additional information related to the entity, a photograph module to generate and display a related photograph section 318, and so forth. The information that appears in the GUI modules may be scraped information, information from a content database, information selected by a party that is responsible for editing the information, information selected by machine learning, or any combination thereof. Such information may include most sought out information for the selected entity. Most sought out information may be gathered from online search logs and other logs pertaining to web browsing.

For each of the modules displayed and rendered by the system circuitry, the system may utilize the image editing circuitry to identify display and graphical elements and to generate tinted glass effects for backdrops, buttons, controls, and other interface elements in a similar manner as described in connection with FIGS. 2a and 2b. In this example, the system circuitry may be utilized to generate tinted glass effects for interactive or actionable interface elements, such as “Summary” button 308 and “More” button 310. As described further in connection with FIGS. 5-7, the tinted glass effect may include one or more semi-transparent layers having alphanumeric text displayed on a front layer. For example, “More” button 310 is depicted having semi-transparent tinted glass effect such that the non-interactive display or graphical element 304 can be seen partially visible under button 310. Similarly, backdrop 302 may be a modified backdrop and may have a tinted glass effect generated using the color palette of the graphical element 304 as described in connection with FIGS. 2a and 2b. In this case, the tinted glass backdrop 302 and graphical element 304 will be partially visible below button 310. Further, the tinted glass effect for a selected button, such as “Summary” button 308 in FIG. 3, may be generated to be less transparent in order to provide a visually emphasized cue to the user that the button is selected, or may be generated using a predetermined static color palette designed to signal to the user the button is currently selected.

Likewise, the tinted glass visual effect can be employed individually for some or all modular elements that are displayed on the GUI. As shown in FIG. 3, the tinted glass effect has been applied to the information retrieved by the mapping module and its respective circuitry in addition to the summary module and its respective circuitry. In this instance, the mapping circuitry has generated and displayed a graphical element in the form of a map having a sub-portion 314 of the graphical element selected for applying the tinted glass visual effect. The sub-portion 314 of the graphical element not only has the tinted glass effect, but also has alphanumeric information 316 generated by the mapping circuitry and displayed on a top layer of the sub-portion 314 of the graphical element.

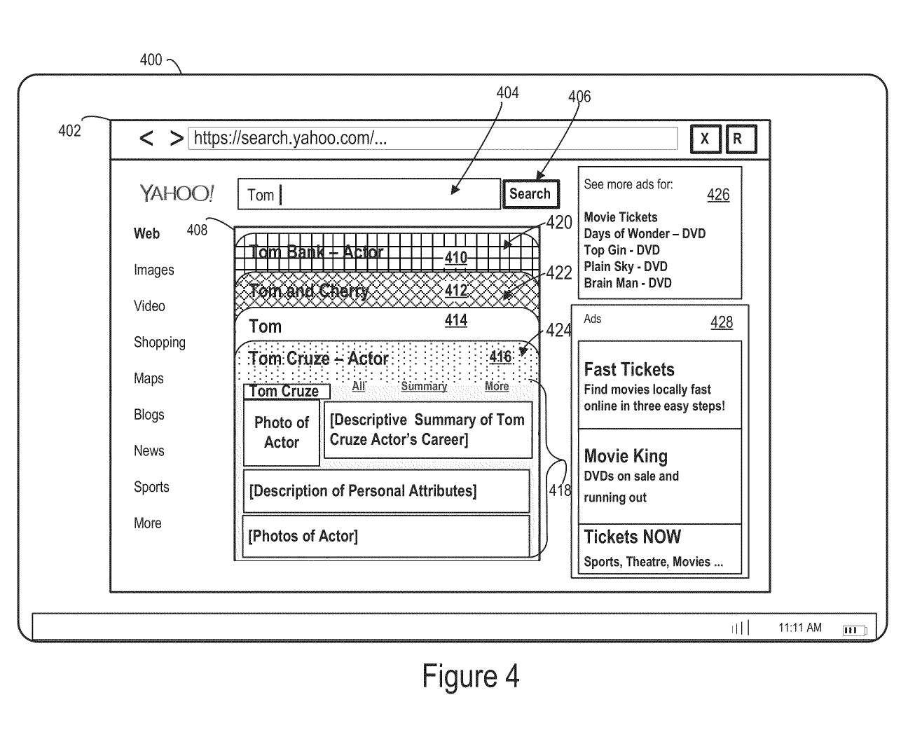

FIG. 4 illustrates entity and non-entity search result objects and search suggestion objects having tinted glass interface elements displayed on an example page view rendered by a client-side application, such as a native web browser executed on a client device 400 according to one embodiment. Client device 400 may be a mobile computing device, such as a laptop or a tablet. Client device 400 contains display 402, which may display the native web browser or client-side application.

The user may enter a search query term in search text field 404 and select execute search query button 406. Similar as in mobile applications, the search results for the search query may be displayed as entity and non-entity search result objects, generic search result objects, and/or search suggestion objects. Entity search result objects, such as entity results 410, 412, and 416 may modified backdrops 420, 422, and 424, respectively. The backdrops may be modified using the tinted glass feature based on a respective color palette associated with each entity result. As described in connection with FIGS. 2a and 2b, the tinted glass visual effects may be dynamically customized based on graphical elements associated with the entity search results, for example when the search results are in partially or fully expanded view, or may be based on the category associated with the search result entity when the search results are in condensed view. Generic search results, such as non-entity result 414, may be not have a modified backdrop or tinted glass visual effect. When a user selects a particular entity search result, the search result may enter fully-expanded or partially expanded view, as shown for entity card 416.

As depicted in FIG. 4, entity search result 416 is depicted in partially expanded view alongside the remaining search result objects. Entity search result 416 is also displayed with information 418 retrieved from one or more module and respective circuitry as described further in connection with FIG. 3. In this instance, entity search result 416 is displayed with summary information 418 related to the entity, as well as modified backdrop 424 having tinted glass effect as part of display portion 408. Display portion 408 is a GUI part provided by the browser or application framework, and portions 426 and 428 are GUI parts provide by the framework and/or a service provider associated with the framework, such as an advertiser.

Referring now to FIG. 5, exemplary operations that may be performed by the circuitry of a client device and/or a server-side device in an exemplary system in order to provide aspects of the modular search result object framework and to generate tinted class visual effects for graphical elements of the search result objects according to one embodiment is depicted. At block 502, a user enters a search query in a search field on a page view displayed on a client device, such as by the user interface of a web-browser or a native application running on the client device. At block 504, the search query is communicated to a framework server over a network, such as network 120. The search query may be received on the server side by the network communications circuitry and communicated to the framework circuitry, such as by one or more processing circuits. The search query may be processed by query processing circuitry, which may form part of the processor circuitry 802 described in connection with FIG. 8, to identify content items related to the search query, such as persons, places, and things that may form object search results for entities search results. At block 506, the framework circuitry receives search results related to the search query, including entity search results, non-entity search results, and/or search suggestions.

At block 508, the framework circuitry may be communicatively coupled to one or more module circuits and entity circuit and may retrieve information for the content items (e.g., persons, places, and things) related to any entity search results. At block 510, various circuitry of the module circuitry, such as summary circuitry or maps circuitry, may process the retrieved information for the content items to generate GUI elements for displaying information and graphical elements to the user. Also at block 510, image editing circuitry may identify any graphical or display elements associated with the content items and the entity search result object. For example, for each content item associated with an entity search result object, the image editing circuitry may identify a graphical display element to be displayed as a background on a collapsed view of a card, a graphical display element to be displayed as a related photograph on a partially expanded view of a card, and/or multiple graphical display elements to display as a sub-portion of one or more modular components on a fully expanded card view.

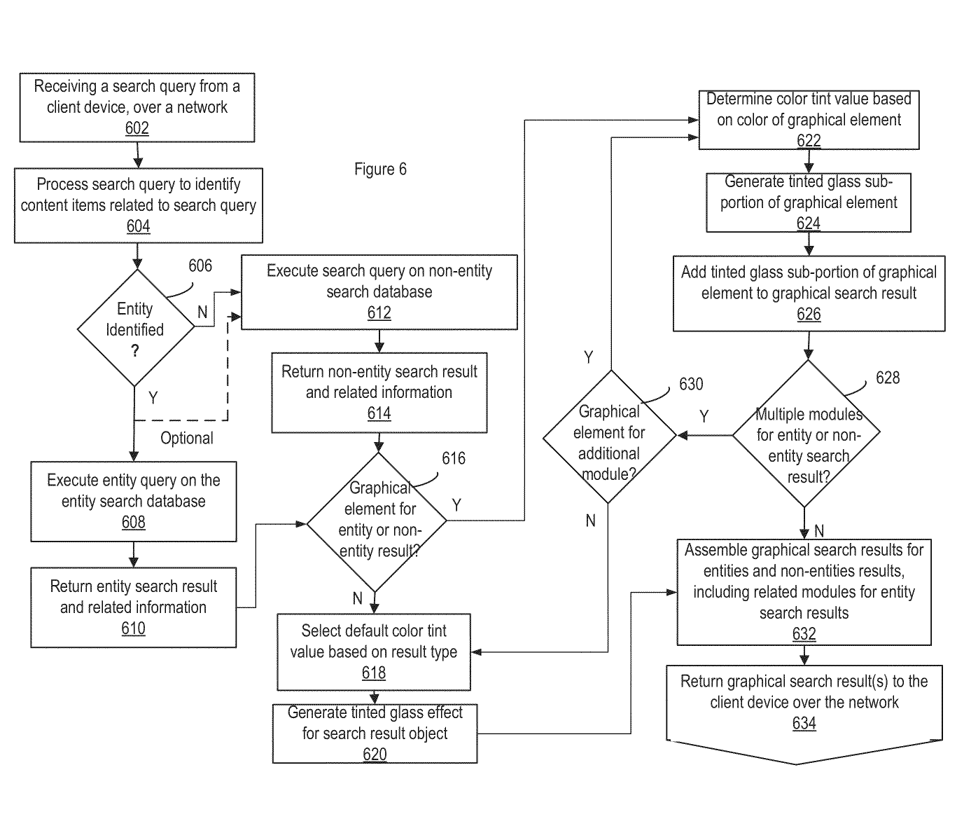

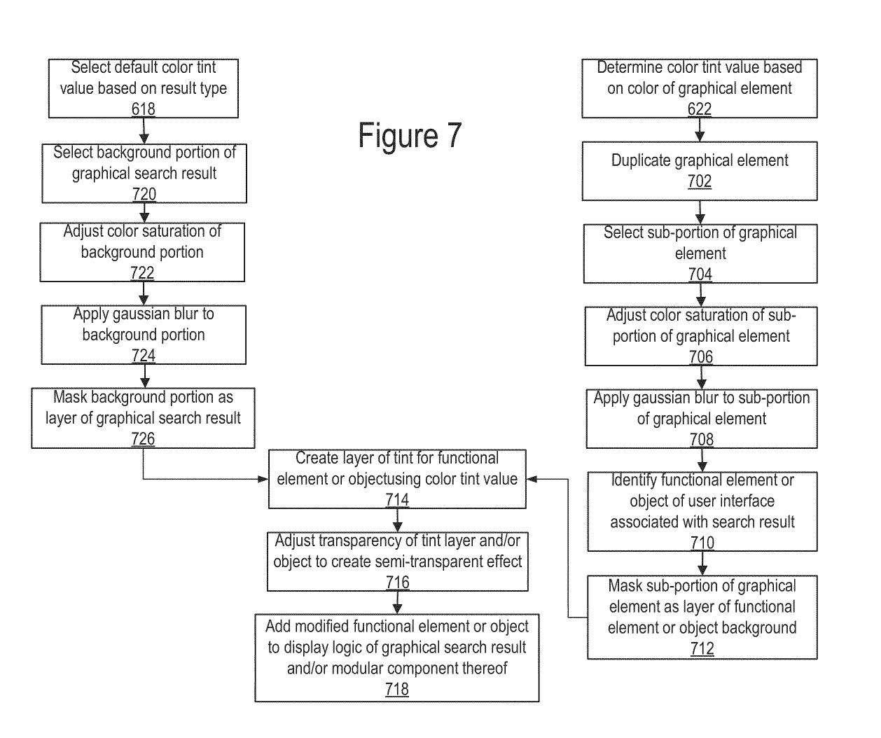

At block 512, for one or more of the graphical display element identified in block 510, image editing circuitry may generate a tinted glass sub-portion of the display element associated with the content item related to the entity search result. For example, the image editing circuitry may generate a tinted glass visual effect as described further in connection with FIGS. 6 and 7. In some embodiments, the image editing circuitry may also generate a tinted glass visual effect for non-entity search results and/or search suggestions. In this scenario, the image editing circuitry may generate the tinted glass according to a pre-defined or static color palette, or a color palette that changes based on the category or type of the non-entity search result and/or search suggestion. For example, all search suggestion results may have a tinted glass visual effect generated according to one or color or palette while all non-entity search results have a tinted glass visual effect generated according a second color or palette. At block 514, the graphical display elements are displayed as part of the entity and/or non-entity search results. For entity search results, the original graphical display element may be displayed as part of each module alongside the relevant information for the content item that was retrieved by the respective modular circuitry. Each graphical display element may be displayed as a portion of the respective module, or as the entire background of the respective modular component of the entity search result object.

At block 516, the tinted glass sub-portion of the graphical display element is added to the graphical display elements that are displayed in each module. The tinted glass sub-portion may be applied as a background of an interactive object or element of a user interface, such as a button or control. For example, a module may have one or more interactive or actionable interface elements, such as the “Summary” or “More” described in connection with the summary module of FIG. 3. For these display elements, the tinted glass may be generated and applied as the entire background of each interactive or actionable button element. Similarly, the tinted glass may form a sub-portion of an interface element. For example, the mapping module described in connection with FIG. 3 may generate and display a map related to the content item. The mapping module may also display a tinted glass sub-portion of the map element having address information for the content item when the content item is a place. Likewise, when entity search results are in partially expanded views, the tinted glass sub-portions may be applied to the background of the top of the card having alphanumeric text and visible to the user. In this case, the sub-portion of the display element may form a small portion of the partially expanded card, or may be the entire visible background of the partially expanded card.

Referring now to FIG. 6, exemplary operations that may be performed by the circuitry of a client device and/or a server-side device in an exemplary system in order to generate tinted class visual effects for search result objects having multiple graphical elements and/or modules are illustrated according to one embodiment. At block 602, a user enters a search query in a search field on a page view displayed on a client device, such as by the user interface of a web-browser or a native application running on the client device. The search query is communicated to a framework server over a network, such as network 120. The search query may be received on the server side by the network communications circuitry and communicated to the framework circuitry, such as by one or more processing circuits. At block 604, the search query may be processed by query processing circuitry associated the one or more processing circuits to identify content items related to the search query, such as persons, places, and things that may form object search results for entities search results. At block, 606 the system processor circuitry determines whether any entity content items are identified in the search query. At block 608, if an entity content item is identified, the system executes the search query for the entity on one or more entity search databases, which, in some embodiments, may include one or more of content database 114, module search framework database 116, or account database 104 described connection with FIG. 1. At block 610, entity circuitry communicatively coupled to the entity search databases return search results and information related to the entity content items. Optionally, the system may also execute the search query on non-entity search databases even when an entity is identified at block 606.

Returning to block 606, if an entity content item is not identified in the search query, system circuitry, such as search suggestion circuitry or webpage search result circuitry, will execute the search query on non-entity search databases, which, in some embodiments, may include one or more of content database 114, module search framework database 116, or account database 104 described connection with FIG. 1. At block 614, search suggestion circuitry or webpage search result circuitry communicatively coupled to the non-entity search databases return search results and information related to the non-entity search result objects and search suggestions. In some embodiments, the non-entity search and entity-search databases may be the same database storing both entity and non-entity data, or each may consist of one or more distributed databases in operative communication over a network, such as the Internet.

At block 616, system circuitry, such as image editing circuitry or entity search result and configuration circuitry, determines whether there are any graphical elements associated with the entity or non-entity objects. The graphical elements may comprise images or photographs associated with the content item, such as portrait, album cover, or promotional photographic, or may comprise other graphical elements retrieved from one or more databases over a network, such as maps of a geographic region associated with the entity or non-entity object. At block 622, if a graphical element is identified, the system circuitry, such as image editing circuitry, may analyze the color of the graphical element to determine a color tint value. For example, the image editing circuitry may identify a predominate color in the image, or may be identify a category associated with the graphical element and identify a pre-determined category color to be used as the color tint value for the graphical element. At block 624, the image editing circuitry will generate a tinted glass sub-portion of the graphical element, such as by using the process described in connection in FIG. 7. At block 626, the tinted glass sub-portion is added to the graphical element of the search result. In some embodiments, the tinted glass sub-portion may form a portion of the graphical element and may have alphanumeric text displayed on a top layer of the tinted glass. The tinted glass sub-portion may also be a semi-transparent layer as to be able to display the features of the graphical image under the semi-transparent tinted glass layer. In other embodiments, the tinted glass sub-portion of the graphical element may cover the entire graphical element and may likewise be semi-transparent as to display the features of the graphical image. For example, a condensed (i.e., non-expanded) search result object or partially expanded search result object for the GAME OF THRONES books may have a graphical element depicting the series of books. The tinted glass sub-portion may be applied to overlay the condensed or partially expanded search result while still allowing the features of the graphical element depicting the series of books to be seen under the semi-transparent tinted glass visual effect, similar to as depicted in element search result object 242 of FIG. 2.

At block 628, the system circuitry, such as the module circuitry, may determine whether there are additional modules that are being displayed for the search result object. If the system circuitry identifies additional modules for the search result object, the system proceeds to be block 630 to determine whether there are any additional graphical elements for the additional modules that require a tinted glass visual effect. If there are additional graphical elements, the system repeats blocks 622, 624, 626, and 628 until there are no more graphical elements requiring a tinted glass visual effect. If there are not graphical elements requiring a tinted glass effect at blocks 630 or 616, the system proceeds to block 618. At block 618, the system may determine a default color tint value for the search result object. In some embodiments, the system may select a default tint color based on the category of the search result object, such as whether the object is an “Actor,” “Book,” “Business,” “TV Series,” or any number of similar categories of search result objects. In other embodiments, the system may not select a tint color value or apply a tinted glass visual effect, for example, if the search result object is a search suggestion or unrecognized search object result. If a tint color is selected, the system generates a tinted glass effect for the search result object at block 620.

After generating the tinted glass effect for the search result object or deciding one is not necessary at block 620 or determining that there are no additional modules at block 628, the system proceeds to block 632. At block 632, the system circuitry, such as the module circuitry, framework circuitry, and/or entity circuitry assembles the graphical search result objects for entities and non-entities results, including the information for any related modules for entity search results. At block 634, the graphical search result objects are returned to the client device over the network by the processing circuitry and the network communications circuitry.

Referring now to FIG. 7, exemplary further operations that may be performed by the circuitry of a client device and/or a server-side device in an exemplary system in order to generate tinted glass visual effects for a graphical element according to one embodiment are illustrated. As described in connection with FIG. 6, at block 622, a color tint value may have identified based on an analysis of the color of the graphical element associated with an entity search result object. In order to generate the tinted glass effect using the color tint value identified in block 622, the system circuitry may utilize some or all of the steps described in connection with FIG. 7. For example, at block 702, the image editing circuitry may first create a duplicate copy of the graphical element. At block 704, the image editing circuitry may then select a sub-portion of that graphical element to be used for applying the tinted glass visual effect. As described in connection with FIG. 6, the sub-portion may form a portion of the graphical element or may form the entire portion of the graphical element depending on the nature of the search result object being processed and/or whether the search result object is in condensed, partially expanded, or full expanded view.

At block 706, the image editing circuitry may adjust the color saturation of the selected sub-portion of the graphical element. For example, in some embodiments the image editing circuitry may adjust a color feature of the selected-sub-portion to adjust the saturation to a level of 20-60%. At block 708, the image editing circuitry may apply a Gaussian blur to the selected sub-portion of the graphical element. For example, in some embodiments, the image editing circuitry may apply a 10-30 pixel Gaussian blur to the selected sub-portion. At block 710, the image editing circuitry may optionally identify functional interface elements of the user interface associated with the search result object. The identified functional interface elements may include interactive or actionable buttons, controls, containers, and other objects, such as the search result objects themselves. At block 712, the image editing circuitry may mask the sub-portion of the graphical element as a layer of the functional element or object, such that the features of the graphical element, whether it be an image or the underlying color palette, are visible as a portion of the functional display element or object. At block 714, a layer of tint is created for the functional display element or object using the color tint value determined in block 622. The layer of tint provides a dynamic color hue to the tinted or frosted glass visual effect that resembles the original graphical element. At block 716, the image editing circuitry may adjust the transparency of the tint layer and/or the duplicated sub-portion of the graphical element. For example, in some embodiments the image editing circuitry may adjust the opacity of the graphical element to 20-80% such that features of the underlying graphical element may appear to be discernable through the saturated and blurred sub-portion.

The precise percentage by which the opacity, blur, and tint of graphical element is adjusted in blocks 706, 708, 716, 722, and 724 may depend on an analysis of the graphical element. For example, in one embodiment, the image may divided into a number of zones. Each zone may be analyzed as a histogram of data presenting information showing the various color features of that zone, such as contrast, brightness, hue, and saturation. If a section of the graphical element is determined have a high brightness value, then the tint, blur, and saturation may be darkened to optimize readability and aesthetic presentation. Similarly, if one or more sections of the graphical element have a high contrast value within a visually complex region of the graphical element, the ting, blur, and saturation would be adjusted to optimize readability and aesthetic presentation. Each of these determinations can be done dynamically and on per-image basis. The number or operations and adjustments that need to be done may change based on the nature of the graphical element at issue. At block 718, the modified functional element or object is added to the display logic for the graphical search result object and/or a modular component thereof by the display logic circuitry and eventually displayed to the user on the user device interface.

Similarly, if the system proceeded to block 618 an analogous process may be used to generate tinted glass for any non-entity search results or search suggestions requiring a tinted glass visual effect. As described further in FIG. 6, at block 618, the system may determine a default color tint value for the search result object, such as based on default color values. At block 720, the image editing circuitry may select a background portion of the graphical search result object. At block 722, the image editing circuitry may adjust the color saturation of the background portion of the graphical search result object. For example, in some embodiments the image editing circuitry may adjust a color feature of the selected-sub-portion to adjust the saturation to a level of 20-60%. At block 724, the image editing circuitry may apply a Gaussian blur to the background portion of the graphical search result object. For example, in some embodiments, the image editing circuitry may apply a 10-30 pixel Gaussian blur to the background portion. At block 726, the image editing circuitry may mask the background portion of the graphical search result object as a layer of the object, such that the features of the graphical search result object, whether it be an image or the underlying color palette, are visible as a portion of the graphical search result object. The process then proceeds to blocks 714, 716, and 718 in a similar manner as previously described.

Throughout the present description, reference is made to a number of system circuits and processors. A person having ordinary skill in the art would recognize that the referenced circuitry are non-limiting examples and that in some embodiments other or additional system circuits may be used as part of the module search framework, or that certain steps and circuitry may be combined as part the same system circuits or a combination of one or more of the referenced circuits.

FIG. 8 illustrates a block diagram of exemplary circuitry of a server in an exemplary system according to one embodiment that can provide aspects of the module search object framework and tinted glass visual effect, such as the modular search framework server 116 illustrated in FIG. 1. FIG. 8 also shows a client device 801 (such as any of the client devices 124-128 of FIG. 1) communicatively coupled to a server 800, over the network 120. The server 900 may include one or more servers, such as the modular search framework server 116. The server 800 includes processor circuitry 802 (such as one or more central processing units) and a system stored in a non-transitory medium 804 executable by the processor circuitry. The processor circuitry 802 may include query processing circuitry having one or more query processing units. The server 800 also includes display logic circuitry 840 generating display logic using information received from various framework circuitry of the system. Display logic circuitry 840 may be implemented by one or more central processing units or likewise stored in the non-transitory medium 804 executable by the processor circuitry. The system is configured to provide several aspects of the framework.

The system includes network communications circuitry 806 and framework circuitry 808. The network communications circuitry 806 and the framework circuitry are communicatively coupled by circuitry. In this disclosure, circuitry may include circuits connected wirelessly as well as circuits connected by hardware, such as wires. The network communications circuitry 806 may be configured to communicatively couple the system to the client device 801 over the network 120. This for example allows an entity card or graphical search result object section provided by the server 800 to be displayed by a client-side application installed on the client device 801.

The framework circuitry 808 includes module circuitry 810, entity circuitry 812, inter-module interface circuitry 814, inter-entity interface circuitry 816, and inter-framework interface circuitry 818. The inter-module interface circuitry 814 may be configured to communicatively couple any of various module circuitry of module circuitry 810. For example, this circuitry 814 may at least communicatively couple entity GUI module circuitry, such as tray module circuitry 820, to one or more other circuitry of the module circuitry 810.

The inter-framework interface circuitry 818 may be configured to communicatively couple at least one entity circuitry of the entity circuitry 812 to any one of the plurality of module circuitry in the module circuitry 810, such as coupling any one of the entity circuitry to the tray module circuitry 820. For the example entity sections illustrated in FIGS. 2a-3, and any modular components thereof, such as for a condensed, semi-expanded, or fully expanded card or graphical search result object, the tray module circuitry may be configured to interact with the at least one entity circuitry to output an interactive entity section to a page view for a corresponding entity.

Also, in such an example, the interactive section may include a plurality of moveable visual objects with information relevant to the corresponding entity. Also, in such an example, the plurality of moveable visual objects may be moveable within the interactive entity section.

These moveable objects and associated functionality can be provide by various module circuitry and even various entity circuitry interoperating by the coupling provided by the inter-framework interface circuitry 818. In an example, the moveable visual objects may be cards, such as condensed, semi-expanded, or fully expanded card or graphical search result objects. Also, the cards or graphical search result objects may have rounded corners as depicted in FIG. 2a-3. A card may include a miniature tray of miniature cards or graphical search result objects within the card and the miniature cards may include information relevant to the entity content item or graphical search result object, as depicted in FIG. 3. Also, the moveable object may include links for navigation between entities, and such objects may be overlapping, such as where a first overlapping object is moveable to view at least part of a second object beneath the first object. Also, the moveable visual objects may be adjacent to or abutting one other object of the moveable objects.

Also, beneficial functionality, such as movement by an object of the plurality of moveable objects being seamless without unintentional visual artifacts, can be due to close coupling of the various circuitry of the framework circuitry 808. Additionally, close coupling between client-side circuitry of the framework circuitry installed on the client device 801 and native operating system circuitry of the client device, circuitry of a client-side application installed on the client device, or both, can facilitate beneficial functionality as well. Code can be communicated from the server 800 to the client device 801, which provides addition and configuration of the client-side circuitry of the framework circuitry for the client device.

The inter-entity interface circuitry 816 may be configured to communicatively couple at least one of the plurality of entity circuitry to one or more other of the plurality of entity circuitry, of the entity circuitry 812. The inter-entity interface circuitry 816 is communicatively coupled to the inter-module interface circuitry 814 by the inter-framework interface circuitry 818. These interconnections can provide a basis for the linking between entities or graphical search result objects as illustrated in FIGS. 2a-3 and corresponding text.

The module circuitry 810 includes various module circuitry, such as the tray module circuitry 820. Other examples of module circuitry within the module circuitry 810 can include entity search result circuitry, search suggestion circuitry, non-entity search result circuitry (such as webpage search result circuitry), maps circuitry, image editing circuitry, and much more. Such circuitry can provide the various structures and operations illustrated in FIGS. 2a-7. As illustrated by FIG. 8, a hierarchy of module circuitry within the circuitry 810 can be extensive. For example as depicted, module circuitry, such as the tray module circuitry 820, can include sub-module circuitry, and that sub-module circuitry can each have sub-module circuitry of its own. For example, a majority of the module circuitry of the circuitry 810 (whether or not a sub-module circuitry) can each at least include sub-module circuitry configuring that circuitry and configuring one or more GUIs provided by that circuitry. The complexities and various arrangements of such a hierarchy are numerous and beyond the scope of this application, and the hierarchical arrangement of the module circuitry of the module circuitry 810 is only one of many effective ways of organizing such circuitry. The example organization of the circuitry of the module circuitry 810 coincides with the arrangement of GUIs and sub-GUIs illustrated in FIGS. 2a-7. However, other arrangements could coincide with the depicted GUIs.

The tray circuitry 820 may include the summary circuitry, the tray configuration circuitry that may include the tray GUI configuration circuitry, and the “more” circuitry associated with the “more” GUI depicted in FIG. 3, for example. Also, as illustrated in FIG. 8, the tray circuitry 820 includes many other sub-circuitry for other functions imaginable by the framework related to a tray object. In FIG. 8, the summary circuitry, such as the respective circuitry providing the summary GUI used to provide text for the modified backdrops illustrated in FIG. 2b, includes configuration circuitry such as circuitry for the configuration of the summary GUI, and analytic circuitry. The analytic circuitry provide for at least part of the predicted desired information by a user provided in the summary GUI. Several GUIs of the framework may be associated with the analytic circuitry of the summary circuitry or other analytic circuitry of module circuitry 810. Such GUIs are likely to incorporate predictively desire information to audience members of the framework.

The entity search result circuitry 822 may provide various functionality and structure associated with retrieving and displaying entity search results, such as the entity search results or graphical search result objects depicted in FIGS. 2a-3, including that of the query processing circuitry. The search suggestion circuitry 824 may provide various functionality and structure associated with retrieving and displaying search suggestions, such as the search suggestions depicted in FIG. 2a. The webpage search result circuitry 826 may provide various functionality and structure associated with retrieving and displaying webpage search results, such as the webpage search results depicted in FIG. 2a. For the purposes of this disclosure, webpage search results and search suggestion results are an example of non-entity search results, which may be generated in whole or in part in conjunction with associated non-entity result circuitry 836. Other example, non-entity search results are image search results associating ambiguously images with a search query. Entity search results or graphical search result objects, are results that include informational objects for a specific entity, such as a particular person, place, or thing. With places and things, there are sub-entities. The maps circuitry 828 may provide various functionality and structure associated with retrieving and displaying map based search results, such as the map search results depicted in FIG. 3. The maps circuitry 828 may include or be associated with navigation circuitry of the module circuitry 810 (such as circuitry including circuitry for discovering routes and device geographic positioning).

Additionally, image editing circuitry 838 may be communicatively coupled to any of the aforementioned circuitry via inter-module interface circuitry 814. Image editing circuitry 838 can process any graphical image elements retrieved from any of the aforementioned circuitry in order to generate tinted glass visual effects as described in connection with FIGS. 2a-7. For example image editing circuitry 838 may receive graphical elements from maps circuitry 828, such as map views, or graphical elements from entity search result circuitry 822 for from any of the individual circuitry of entity circuitry 812, such as photographs associated with the entity search result object. As mentioned, each of the module circuitry may include sub-module circuitry, such as corresponding user interface circuitry, configuration circuitry, analytic circuitry, data processing circuitry, query processing circuitry, data storage circuitry, data retrieval circuitry, navigation circuitry, or any combination thereof. A complete listing of the various types of module circuitry and sub-module circuitry are numerous and beyond the scope of this application. The examples of module circuitry described herein and shown in FIG. 9 are merely illustrative of the expansiveness of the framework.

The entity circuitry 812 includes various types of entity circuitry, including people circuitry 830, place circuitry 832, and thing circuitry 834. The people circuitry 830 includes individual circuitry for each particular person that can be identified as an entity by the framework. A particular person can be an actual living person or a person who has passed away. Well-known people, who are often searched online, such as celebrities, may be automatically inputted into the framework and hence circuits generated for those people automatically. Less known people, such as a regular Joe starting a small business, may submit an application for a circuit to be generated for themselves or a business and/or product they wish to market through the framework. A particular person can also be a character in a fictional work. For fictional characters, there may be a plurality of entities for a known character. For example, the character Supermom may have an entity circuit for each entered iteration of the Supermom character inputted into the framework, such as a plurality of Supermoms from the different Supermom movies and television series, and a plurality of Supermoms from the different versions of the Supermom Comic Book. A person entity becomes identifiable when a corresponding entity has been submitted and accepted by the framework. At that point, a circuit can be generated for that person entity. The front end for the modular search framework server 116 can facility entry of entities, such as people entities.

The place circuitry 832 includes individual circuitry for each particular location that can be identified as an entity by the framework. A particular location can be an address, a global positioning point, an actual location not having an address, or combination thereof. Actual locations not having an address can be submitted through an application process, such as an obscure park. Locations that are commonly searched without an address can be automatically inputted into the system as circuits, such as a national park. In other words, well-known places, which are often searched online, such as landmarks, government administrated parks, cities, countries, and even well-known bodies of water, may be automatically inputted into the framework and hence circuits generated for those places automatically. Less known places, such as an ordinary parking lot without an address, may be submitted via an application for a circuit to be generated for that place. Businesses and products may be marketed through a place entity, for example. Places can be any geographic entity, whether that entity is fictional, non-fictional, still in existence, historical, or some combination thereof. For fictional places, there may be a plurality of entities for a known fictional place. For example, each iteration of Atlantis used in fictional works may have its own entity circuit. A place entity becomes identifiable when a corresponding entity has been submitted and accepted by the framework. At that point, a circuit can be generated for that place entity. The front end for the modular search framework server 116 can facility entry of entities, such as place entities.

The thing circuitry 832 includes individual circuitry for each particular thing that can be identified as an entity by the framework. A particular organization, product, service, named organism, (such as a pet or famous circus animal), can be a thing entity. Thing entities can overlap with places entities and fictional character entities, for example, a geographic location like the dark side of the moon may be a thing as well. Also, for example, the Witch of Oyo may be a thing entity (such as a movie entity), and a character entity, such as the Witch of Oyo the character in the original movie production. Also, there may several iterations of a thing. To continue with the Witch of Oyo theme, there may be several well-known productions of this movie in a live theatre format. Well-known things, which are often searched online, such as movies, mass manufactured products, and a large companies, may be automatically inputted into the framework and hence circuits generated for those places automatically. Less known things, such as a new product developed by an ordinary Joe, may be submitted via an application for a circuit to be generated for that thing. Services and products may be marketed through a thing entity, for example. Things can be almost any unambiguous thing that can be claimed. Rules for what can be claimed or what is considered ambiguous are beyond the scope of this application. Things can be fictional, non-fictional, still in existence, historical, or some combination thereof. A thing entity becomes identifiable when a corresponding entity has been submitted and accepted by the framework. At that point, a circuit can be generated for that thing entity. The front end for the modular search framework server 116 can facility entry of entities, such as thing entities.

The each particular person, place, or thing circuitry of the entity circuitry 812 can include and provide respective data models for gathering, maintaining, and entering information on that corresponding entity. These data models can also act as an interface for data requested various operations provided by the module circuitry 810. Each particular entity circuitry may also include logic for facilitating operations between the various module circuitry of the circuitry 810 and databases storing information on entities. In other words, these entity circuitry may act a middleware between functions and data. Regarding the example fully expanded entity screen in FIG. 3, various functions are being called which are providing by the module circuitry 810, such as functions of the summary module circuitry. For a function of the summary module circuitry to retrieve information on Big Cup Coffee the place, the function communicates with the particular entity circuitry for Big Cup Coffee the place, such as place circuitry 832. This particular entity circuitry may have the information on Big Cup Coffee the place cached or permanently stored within its circuitry or may request the information from a database, such as a database specifically for the modular search framework server 116 (not depicted in FIG. 1) and/or the content database 114 or ad database 110.

Returning to FIG. 1, the network 120 may also be or include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

The network 120 may be or include a peer-to-peer network. A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

The network 120 may be or include a social network. The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The network environment 120 may be configured or operable for multi-modal communication which may occur between members of a social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, SMS/MMS, email, instant messenger clients, forums, social networking sites (such as Facebook, Twitter, or Google+), or the like.

As described, the search engine server 106 and/or the modular search framework server 116 may include a crawler component, an indexer component, an index storage component, a search component, a ranking component, a cache, a user or group profile storage component, an entity storage component, a logon component, a user or group profile builder, an entity builder, and application program interfaces (APIs), such as APIs corresponding with the modular search framework. A search engine may enable a device, such as a client device, to search for files of interest using a search query. Typically, a search engine may be accessed by a client device via one or more servers. A search engine may be deployed in a distributed manner, such as via a set of distributed servers, for example. Components may be duplicated within a network, such as for redundancy or better access.

A crawler may be operable to communicate with a variety of content servers, typically via network. In some embodiments, a crawler starts with a list of URLs to visit, which may be referred to as a seed list. As the crawler visits the URLs in the seed list, it may identify some or all the hyperlinks in the page and add them to a list of URLs to visit, which may be referred to as a crawl frontier. URLs from the crawler frontier may be recursively visited according to a set of policies. A crawler typically retrieves files by generating a copy for storage, such as local cache storage. A cache may refer to a persistent storage device. A crawler may likewise follow links, such as HTTP hyperlinks, in the retrieved file to additional files and may retrieve those files by generating copy for storage, and so forth. A crawler may therefore retrieve files from a plurality of content servers as it “crawls” across a network.

An indexer may be operable to generate an index of content, including associated contextual content, such as for one or more databases, which may be searched to locate content, including contextual content. An index may include index entries, wherein an index entry may be assigned a value referred to as a weight. An index entry may include a portion of the database. In some embodiments, an indexer may use an inverted index that stores a mapping from content to its locations in a database file, or in a document or a set of documents. A record level inverted index contains a list of references to documents for each word. A word level inverted index additionally contains the positions of each word within a document. A weight for an index entry may be assigned. For example, a weight, in one example embodiment may be assigned substantially in accordance with a difference between the number of records indexed without the index entry and the number of records indexed with the index entry.

The term “Boolean search engine” refers to a search engine capable of parsing Boolean-style syntax, such as may be used in a search query. A Boolean search engine may allow the use of Boolean operators (such as AND, OR, NOT, or XOR) to specify a logical relationship between search terms. For example, the search query “college OR university” may return results with “college,” results with “university,” or results with both, while the search query “college XOR university” may return results with “college” or results with “university,” but not results with both.

In contrast to Boolean-style syntax, “semantic search” refers a search technique in which search results are evaluated for relevance based at least in part on contextual meaning associated with query search terms. In contrast with Boolean-style syntax to specify a relationship between search terms, a semantic search may attempt to infer a meaning for terms of a natural language search query. Semantic search may therefore employ “semantics” (e.g., science of meaning in language) to search repositories of various types of content.

Search results located during a search of an index performed in response to a search query submission may typically be ranked. An index may include entries with an index entry assigned a value referred to as a weight. A search query may comprise search query terms, wherein a query term may correspond to an index entry. In an embodiment, search results may be ranked by scoring located files or records, for example, such as in accordance with number of times a query term occurs weighed in accordance with a weight assigned to an index entry corresponding to the query term. Other aspects may also affect ranking, such as, for example, proximity of query terms within a located record or file, or semantic usage, for example. A score and an identifier for a located record or file, for example, may be stored in a respective entry of a ranking list. A list of search results may be ranked in accordance with scores, which may, for example, be provided in response to a search query. In some embodiments, machine-learned ranking (MLR) models are used to rank search results. MLR is a type of supervised or semi-supervised machine learning problem with the goal to automatically construct a ranking model from training data.

In one embodiment, as an individual interacts with a software application, e.g., an instant messenger or electronic mail application, descriptive content, such in the form of signals or stored physical states within memory, such as, for example, an email address, instant messenger identifier, phone number, postal address, message content, date, time, etc., may be identified. Descriptive content may be stored, typically along with contextual content. For example, how a phone number came to be identified (e.g., it was contained in a communication received from another via an instant messenger application) may be stored as contextual content associated with the phone number. Contextual content, therefore, may identify circumstances surrounding receipt of a phone number (e.g., date or time the phone number was received) and may be associated with descriptive content. Contextual content, may, for example, be used to subsequently search for associated descriptive content. For example, a search for phone numbers received from specific individuals, received via an instant messenger application or at a given date or time, may be initiated.

Content within a repository of media or multimedia, for example, may be annotated. Examples of content may include text, images, audio, video, or the like, which may be processed in the form of physical signals, such as electrical signals, for example, or may be stored in memory, as physical states, for example. Content may be contained within an object, such as a Web object, Web page, Web site, electronic document, or the like. An item in a collection of content may be referred to as an “item of content” or a “content item,” and may be retrieved from a “Web of Objects” comprising objects made up of a variety of types of content. The term “annotation,” as used herein, refers to descriptive or contextual content related to a content item, for example, collected from an individual, such as a user, and stored in association with the individual or the content item. Annotations may include various fields of descriptive content, such as a rating of a document, a list of keywords identifying topics of a document, etc.

A profile builder may initiate generation of a profile, such for users of an application, including a search engine, for example. A profile builder may initiate generation of a user profile for use, for example, by a user, as well as by an entity that may have provided the application. For example, a profile builder may enhance relevance determinations and thereby assist in indexing, searching or ranking search results. Therefore, a search engine provider may employ a profile builder, for example. A variety of mechanisms may be implemented to generate a profile including, but not limited to, collecting or mining navigation history, stored documents, tags, or annotations, to provide a few examples. A profile builder may store a generated profile. Profiles of users of a search engine, for example, may give a search engine provider a mechanism to retrieve annotations, tags, stored pages, navigation history, or the like, which may be useful for making relevance determinations of search results, such as with respect to a particular user.

Advertising may include sponsored search advertising, non-sponsored search advertising, guaranteed and non-guaranteed delivery advertising, ad networks/exchanges, ad targeting, ad serving, and/or ad analytics. Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

An “ad server” comprises a server that stores online advertisements for presentation to users. “Ad serving” refers to methods used to place online advertisements on websites, in applications, or other places where users are more likely to see them, such as during an online session or during computing platform use, for example.

During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

While the computer-readable medium as described or set forth in the appended claim may be described as a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed herein. The “computer-readable medium” may be non-transitory, and may be tangible.

Note that dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A system stored in a non-transitory medium executable by processor circuitry, comprising:
interface circuitry configured to receive a search query;
query processing circuitry configured to identify a content item related to the search query and to retrieve data for the content item;
image editing circuitry communicatively coupled to the query processing circuitry and configured to:
identify a display element associated with the content item from the retrieved data;
dynamically generate a semi-transparent portion of the display element; and
apply the semi-transparent portion of the display element to a background of an interface element; and
display logic circuitry communicatively coupled to the interface circuitry and configured to display, in response to the search query, the interface element as a sub-portion of the display element associated with the content item.

2. The system of claim 1, wherein dynamically generating a semi-transparent portion of the display element comprises:
duplicating the display element;
adjusting a color feature of the display element to create a semi-saturated display element; and
selecting a sub-portion of the semi-saturated display element.

3. The system of claim 2, wherein dynamically generating a semi-transparent portion of the display element further comprises:
masking the sub-portion of the semi-saturated display element as a layer of the display element;
creating a color tint layer as a top layer of the display element; and
adjusting the transparency of the semi-transparent portion of the display element.

4. The system of claim 1, wherein the displayed interface element is an actionable display element that may be selected by a user.

5. The system of claim 4, wherein the image editing circuitry is further configured to visually emphasize the actionable display element by decreasing a transparency value of the semi-transparent portion of the display element when it is selected by the user.

6. The system of claim 1, wherein the semi-transparent portion of the display element contains a dynamically generated color tint layer.

7. The system of claim 6, wherein the image editing circuitry is further configured to dynamically generate the color tint layer by processing the display element to identify and select one or more predominate colors from the display element.

8. The system of claim 1 wherein the image editing circuitry is further configured to:
identify a second display element associated with the content item;
dynamically generate a semi-transparent portion of the second display element;
apply the semi-transparent portion of the display element to a background of a second interface element.

9. The system of claim 8, wherein the display logic circuitry is further configured to display the second interface element as a sub-portion of second display element.

10. The system of claim 1, wherein the display logic circuitry is further configured to add text to the interface element and display the interface element as a search result in response to the search query.

11. A computer-implemented method comprising:
processing, by query processing circuitry communicatively coupled to a network communications circuitry, a search query to identify search result objects associated with the search query;
receiving, at the network communications circuitry, a search result object associated with the search query and a graphical display element related to the search result object;
processing, by image editing circuitry, the graphical display element for the search result object to dynamically generate a semi-transparent portion of the graphical display element;
identifying, by the image editing circuitry, an interface element associated with the search result object and applying the semi-transparent portion of the graphical display element as a background of the interface element; and
generating, by display logic circuitry, display logic for displaying graphical search result objects to a user including the search result object and the semi-transparent portion of the graphical display element as a background of the interface element.

12. The method of claim 11, wherein processing a search query to identify search result objects associated with the search query comprises:
receiving, by network communications circuitry, a search query from a search field on a page view displayed on a client device; and
retrieving, by entity circuitry communicatively coupled to the network communications circuitry, entity search result objects related to the search query and information related to the entity search result objects.

13. The method of claim 11, wherein processing the graphical display element for the search result object to dynamically generate a semi-transparent portion of the graphical display element comprises:
duplicating a portion of the graphical display element;
adjusting the color saturation of the portion of the graphical display element; and
masking the portion of the graphical display element as a layer of the a semi-transparent portion of the graphical display element.

14. The method of claim 13, wherein processing the graphical display element for the search result object to dynamically generate a semi-transparent portion of the graphical display element further comprises:
dynamically adding a color tint later to the semi-transparent portion of the graphical display element;
adjusting the transparency of the semi-transparent portion of the graphical display element; and
applying the semi-transparent portion of the graphical display element as a background of an interface element.

15. The method of claim 11, wherein the interface element is an interactive control, action button, container, or object.

16. The method of claim 11, further comprising:
identifying, by module circuitry, a second graphical display element related to the search result object;
processing, by the image editing circuitry, the second graphical display element to dynamically generate a second semi-transparent portion of the second graphical display element; and
identifying, by the image editing circuitry, a second interface element associated with the search result object and applying the second semi-transparent portion of the second graphical display element as a background of the second interface element.

17. The method of claim 16, wherein generating, by the display logic circuitry, display logic for displaying graphical search result objects to a user, further comprises:
including the second semi-transparent portion of the second graphical display element as a background of the second interface element with the search result object.

18. The method of claim 11, wherein the semi-transparent portion of the graphical display element contains a dynamically generated color tint layer based on a color palette of the graphical display element.

19. The method of claim 11, wherein the displayed semi-transparent portion of the graphical display element contains alphanumeric text related to the search query and is displayed as a search result on a display of a user device.

20. A system, comprising:
a means for receiving a user search query and identifying a graphical element associated with a search result object related to the search query;
a means for generating a tinted glass visual effect for a portion of the graphical element;
a means for displaying the tinted glass visual effect on the portion of graphical element as part of a graphical search result related to the search query; and
a means for outputting the graphical search result to be displayed on a display of a client device.
